(19) United States
(12) Patent Application Publication
(10) Pub. No.: US 2014/0325378 A1
(43) Pub. Date: Oct. 30, 2014

(54) Method and apparatus for generating a personalized page

(71) Applicant: TENCENT TECHNOLOGY (SHENZHEN) COMPANY LIMITED, SHENZHEN (CN)

(72) Inventor: Xin Chen, Shenzhen (CN)

(21) Appl. No.: 14/317,876

(22) Filed: Jun. 27, 2014

Related U.S. Application Data
(63) Continuation of application No. PCT/CN2014/073326, filed on Mar. 12, 2014.

(30) Foreign Application Priority Data
Mar. 12, 2013 (CN) 2013100786109

(51) Int. Cl. H04L 29/08

(52) U.S. Cl. CPC H04L 67/22
USPC 715/745

(57) ABSTRACT

A method for generating a personalized page is provided, in which: various characteristic behaviours of a user when the user visits a website are recorded, and for each of the characteristic behaviours, information of a subject matter corresponding to the characteristic behaviour is recorded, a page request is received from a client, and in response to the page request, a current behaviour of the user is detected, if the current behaviour belongs to one of the various characteristic behaviours, recorded information of all subject matters corresponding to the current behaviour is acquired, and a personalized page is generated according to the information of all subject matters corresponding to the current behaviour, and the personalized page is returned to the client. Additionally, an apparatus and a server for generating a personalized page are also provided.

### CROSS-REFERENCE TO RELATED APPLICATIONS

This is a continuation application of International Patent Application No. PCT/CN2014/073326, filed on Mar. 12, 2014, which claims priority to Chinese Patent

Application No. 201310078610.9 filed on Mar. 12, 2013, the disclosure of which is hereby incorporated by reference herein in its entirety.

### TECHNICAL FIELD

The disclosure relates to the field of internet technology, and in particular to a method and apparatus for generating a personalized page.

### BACKGROUND

With the rapid development of internet technology, various information service websites show a strong trend of rapid growth. Click rate refers to a ratio between the number of times a piece of content on a web page is clicked and the number of times the page is displayed. It is a percentage, which reflects the degree of concern of a piece of content on a web page. If the click rate of each piece of content on a page is zero, it is essentially equivalent to the piece of content being valueless for a user. Therefore, how to improve click rate of content on a web page by various technical means becomes one of the key technical problems to be solved by various network service providers.

### SUMMARY

This disclosure in some aspects relates to a method and apparatus for generating a personalized page, capable of improving click rate of content on a web page.

According to an aspect of the disclosure, a method for generating a personalized page is provided, which includes steps as follows: recording various characteristic behaviours of a user when the user visits a website, and, for each of the characteristic behaviours, recording information of a subject matter corresponding to the characteristic behaviour; receiving a page request from a client and, in response to the page request, detecting a current behaviour of the user; if the current behaviour belongs to one of the various characteristic behaviours, acquiring recorded information of all subject matters corresponding to the current behaviour; and generating a personalized page according to the information of all subject matters corresponding to the current behaviour, and returning the personalized page to the client.

According to another aspect of the disclosure, an apparatus for generating a personalized page is provided, which includes: a recording portion, configured to record various characteristic behaviours of a user when the user visits a website, and, for each of the characteristic behaviours, record information of a subject matter corresponding to the characteristic behaviour; a receiving portion, configured to receive a page request from a client and, in response to the page request, detect a current behaviour of the user; an acquisition portion, configured to acquire recorded information of all subject matters corresponding to the current behaviour when the current behaviour belongs to one of the various characteristic behaviours; and a generating portion, configured to generate a personalized page according to the information of all subject matters corresponding to the current behaviour, and to return the personalized page to the client.

According to yet another aspect of the disclosure, a server is provided, which includes a processor and a memory coupled to the processor and including instructions that when executed, cause the processor to perform the following method: recording various characteristic behaviours of a user when the user visits a website, and, for each of the characteristic behaviours, recording information of a subject matter corresponding to the characteristic behaviour; receiving a page request from a client and, in response to the page request, detecting a current behaviour of the user; if the current behaviour belongs to one of the various characteristic behaviours, acquiring recorded information of all subject matters corresponding to the current behaviour; and generating a personalized page according to the information of all subject matters corresponding to the current behaviour, and returning the personalized page to the client.

According to yet another aspect of the disclosure, a non-transitory computer-readable storage medium is provided, which includes instructions that, when executed, cause the processor to perform the following method: recording various characteristic behaviours of a user when the user visits a website, and, for each of the characteristic behaviours, recording information of a subject matter corresponding to the characteristic behaviour; receiving a page request from a client and, in response to the page request, detecting a current behaviour of the user; if the current behaviour belongs to one of the various characteristic behaviours, acquiring recorded information of all subject matters corresponding to the current behaviour; and generating a personalized page according to the information of all subject matters corresponding to the current behaviour, and returning the personalized page to the client.

This section is intended to provide an overview of subject matter of the present patent application. It is not intended to provide an exclusive or exhaustive explanation of the invention. The detailed description is included to provide further information about the present patent application.

### DESCRIPTION OF THE DRAWINGS

These and other sample aspects of the disclosure will be described in the detailed description and the claims that follow, and in the accompanying drawings, wherein:

FIG. 1 is a flow chart of a method for generating a personalized page according to a first embodiment of the disclosure;

FIG. 2 is an exemplary diagram for acquiring information of a subject matter according to the method of the first embodiment;

FIG. 3 is a flow chart of a method for generating a personalized page according to a second embodiment of the disclosure;

FIG. 4 is an exemplary diagram for selecting information of a subject matter according to the method of the second embodiment;

FIG. 5 is a block diagram of an apparatus for generating a personalized page according to a third embodiment of the disclosure;

FIG. 6 is a block diagram of an apparatus for generating a personalized page according to a fourth embodiment of the disclosure; and

FIG. 7 is a block diagram illustrating a server for generating a personalized page according to some embodiments.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

Reference throughout this specification to “an example,” “an embodiment,” or the like in the singular or plural means that one or more particular features, structures, or characteristics described in connection with an embodiment is included in at least one embodiment of the present disclosure. Thus, the appearances of the phrases “an example,” “an embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

Compared to the prior art, the technical solution of the disclosure records information of subject matters corresponding to various characteristic behaviours when a user visits a website, and when the user visits the website again, generates a personalized page according to the need reflected by a current behaviour of the user, thus it can improve the click rate of content on a web page.

In order to make the above and other objectives, features and advantages of the disclosure clear and better understood, detailed description will be made below by illustrating preferred embodiments with reference to accompanying drawings.

### First Embodiment

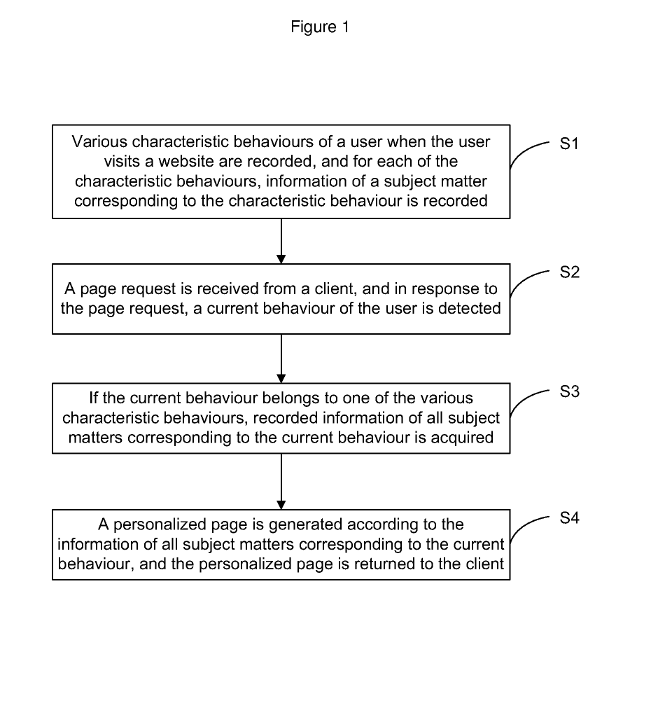

Referring to FIG. 1, the first embodiment of the disclosure provides a method for generating a personalized page, the method includes following steps:

step S1: Various characteristic behaviours of a user when the user visits a website are recorded, and for each of the characteristic behaviours, information of a subject matter corresponding to the characteristic behaviour is recorded;

step S2: A page request is received from a client, and in response to the page request, a current behaviour of the user is detected;

step S3: If the current behaviour belongs to one of the various characteristic behaviours, recorded information of all subject matters corresponding to the current behaviour is acquired; and

step S4: A personalized page is generated according to the information of all subject matters corresponding to the current behaviour, and the personalized page is returned to the client.

Detailed description will be made below with reference to specific examples.

The website in step S1 may be for example an electronic business website providing a transaction platform for online shopping, a news website, a video playing/downloading website, a picture browsing website and the like. The subject matter may be content displayed by a web page, such as a commodity, a piece of news, a video, a picture and the like. Taking the subject matter being a commodity displayed by a web page as an example, information of the subject matter may include information about the name, price, merchant, model, classification and function description of the commodity. The characteristic behaviour is defined as some specific behaviours imposed on the subject matter by a user, such as clicking and checking, playing, searching, buying, sharing and the like. Various characteristic behaviours are prioritized. The various characteristic behaviours and information of their corresponding subject matters are recorded in a database of a computer or a server that visits the website.

In step S2, when a user logins into the website on the client, or browses any page of the website without logining into it, the page request will be sent. After the page request of the client is received, a current behaviour of the user will be detected, and it will be determined whether the current behaviour belongs to one of the defined characteristic behaviours.

In step S3, if the current behaviour belongs to one of the various characteristic behaviours, information of all subject matters corresponding to the characteristic behaviour to which the current behaviour belongs is acquired from the database. It is necessary to noted that if there is no information record of subject matters corresponding to the characteristic behaviour to which the current behaviour belongs in the database, information of all the subject matters corresponding to the characteristic behaviour having a corresponding subject matter and with a highest priority is acquired among all characteristic behaviours with their priorities lower than the priority of a characteristic behaviour to which the current behaviour belongs.

The personalized page in step S4 will show information of all subject matters corresponding to the current behaviour, for example showing the information of all the subject matters by rolling or arranging them. Since the content on the personalized page is generated according to recorded information of a subject matter corresponding to a characteristic behaviour of a user, the content on the personalized page is more in line with the user's interest and need, thus improving the click rate of the content on the page.

In a specific example, the website is an electronic business website, and the subject matter is a commodity. The characteristic behaviours include five behaviours, which are ordered in a order of priority from lowest to highest as: Attention behaviour, Interest behaviour, Search behaviour, Action behaviour and Share behaviour. Then, the step SI specifically includes:

If a user merely browses a page of a commodity once but doesn't buy the commodity, information of the commodity is recorded as information of a subject matter corresponding to the Attention behaviour;

If a user browses a page of a commodity more than a predetermined number of times but doesn't buy the commodity, information of the commodity is recorded as information of a subject matter corresponding to the Interest behaviour;

If a user searches a page of a commodity by inputting a keyword or selecting a filtering option, information of the commodity is recorded as information of a subject matter corresponding to the Search behaviour;

If a user successfully buys a commodity on the page of the commodity, information of the commodity is recorded as information of a subject matter corresponding to the Action behaviour; and

If a user releases a page linkage of a commodity on the information releasing platform of the electronic business website after buying successfully the commodity, information of the commodity is recorded as information of a subject matter corresponding to the Share behaviour.

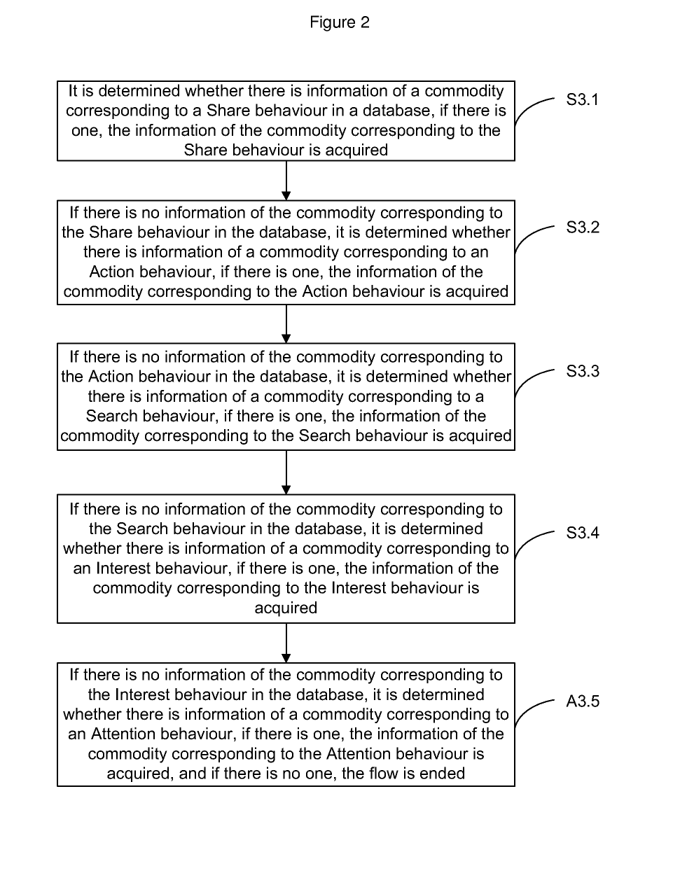

Referring to FIG. 2, in the example, if the current behaviour is a Share behaviour, step S3 will include:

step S3.1: It is determined whether there is information of a commodity corresponding to a Share behaviour in a database, if there is one, the information of the commodity corresponding to the Share behaviour is acquired, if there is no one, proceed to step S3.2;

step S3.2: It is determined whether there is information of a commodity corresponding to an Action behaviour, if there is one, the information of the commodity corresponding to the Action behaviour is acquired; if there is no one, proceed to step S3.3;

step S3.3: It is determined whether there is information of a commodity corresponding to a Search behaviour, if there is one, the information of the commodity corresponding to the Search behaviour is acquired, if there is no one, proceed to step S3.4;

step S3.4: It is determined whether there is information of a commodity corresponding to an Interest behaviour, if there is one, the information of the commodity corresponding to the Interest behaviour is acquired, if there is no one, proceed to step S3.5; and step S3.5: It is determined whether there is information of a commodity corresponding to an Attention behaviour, if there is one, the information of the commodity corresponding to the Attention behaviour is acquired, and if there is no one, the flow is ended.

In conclusion, the method for generating a personalized page provided by the embodiment records information of subject matters corresponding to various characteristic behaviours of a user when the user visits a website, and when the user visits the website again, generates a personalized page according to the need reflected by a current behaviour of the user, thus it can improve the click rate of content on a web page.

### Second Embodiment

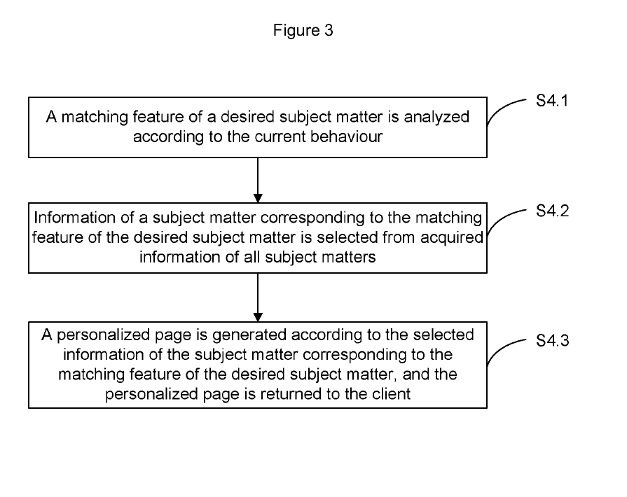

In order to select more accurately a subject matter more in line with a user's interest and need from all subject matters corresponding to a current behaviour, as shown in FIG. 3, a method for generating a personalized page is provided according to a second embodiment of the disclosure, compared to the method for generating a personalized page according to the first embodiment, the above step S4 includes:

step S4.1: A matching feature of a desired subject matter is analyzed according to the current behaviour. For example, the current behaviour may be a Search behaviour, the user may input some keywords or select some filtering options, then the matching feature of the desired subject includes the inputted keywords or the filtering options. Multiple matching features can be defined for the desired subject matter, and the multiple matching features are prioritized; and step S4.2: Information of a subject matter corresponding to the matching feature of the desired subject matter is selected from acquired information of all subject matters. For example, the matching feature of the desired subject matter may include a keyword and a category, then information of a subject matter with the same keyword and category as those of the desired subject matter is selected from acquired information of all subject matters.

In addition, since the desired subject matter may have multiple matching features, in order to acquire more accurate results, information of a subject matter corresponding to a matching feature having a corresponding subject matter and with a highest priority may be selected among the multiple matching features of the desired subject matter according to priorities set to the multiple matching features.

step S4.3: A personalized page is generated according to the selected information of the subject matter corresponding to the matching feature of the desired subject matter, and the personalized page is returned to the client

Referring back to the specific example provided in the first embodiment, three matching features of the desired subject are defined, they are ordered in a order of priority from highest to lowest as: Keyword, Category and Topic.

The keyword is a keyword of a commodity's name or function description, such as name, brand and trait of a winter coat. When a user browses, buys or shares a commodity, the name or function description of the commodity can be extracted as a keyword of the desired commodity. When a user searches a commodity, the keyword input by the user or the filtering option set by the user can be extracted as a keyword of the desired commodity.

The category is a classification to which a commodity belongs, such as kitchen ware, clothing, household appliances and the like. When a user browses, buys or shares a commodity, the category of the commodity can be extracted as a category of the desired commodity. When a user searches a commodity, the category of the desired commodity can be analyzed according to the keyword input or the filtering option set by the user. For example, when a user inputs a keyword of “sweater”, then “clothing” will be regarded as the category of the desired commodity.

The topic is an interrelated theme between a commodity and other commodities of the same or different category, for example, a topic between an iPhone mobile phone and an iPad tablet may be “Apply Inc.”. When a user browses, buys or shares a commodity, the topic of the desired commodity can be analyzed according to the name, merchant or function description of the commodity. When a user searches a commodity, the topic of the desired commodity can be analyzed according to the keyword input or the filtering option set by the user.

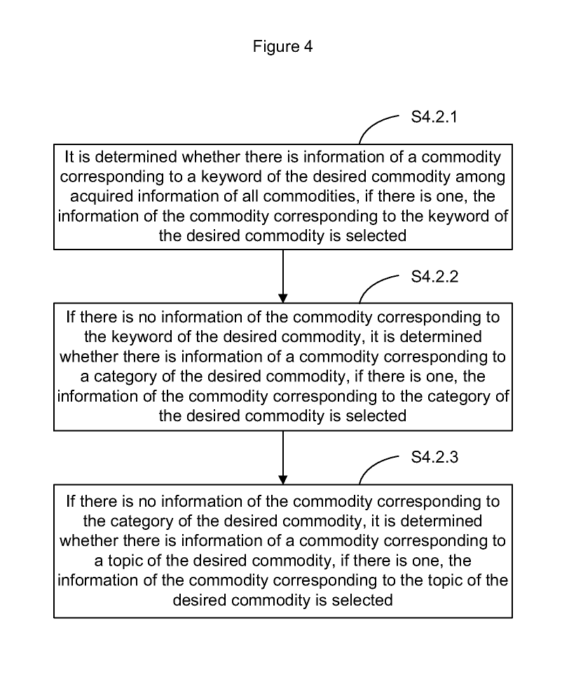

Referring to FIG. 4, in the example, the step S4.2 will include:

step S4.2.1: It is determined whether there is information of a commodity corresponding to a keyword of the desired commodity among acquired information of all commodities, if there is one, the information of the commodity corresponding to the keyword of the desired commodity is selected, if there is no one, proceed to step S4.2.2;

step S4.2.2: It is determined whether there is information of a commodity corresponding to a category of the desired commodity, if there is one, the information of the commodity corresponding to the category of the desired commodity is selected, if there is no one, proceed to step S4.2.3; and step S4.2.3: It is determined whether there is information of a commodity corresponding to a topic of the desired commodity, if there is one, the information of the commodity corresponding to the topic of the desired commodity is selected, if there is no one, the flow of step S4.2 is ended.

In conclusion, compared to the method for generating a personalized page provided by the first embodiment, the method for generating a personalized page provided by the current embodiment can select more accurately information of a subject matter more in line with a user's interest and need so as to generate a personalized page from information of all subject matters corresponding to a current behaviour, thus it can further improve click rate of content on a web page.

### Third Embodiment

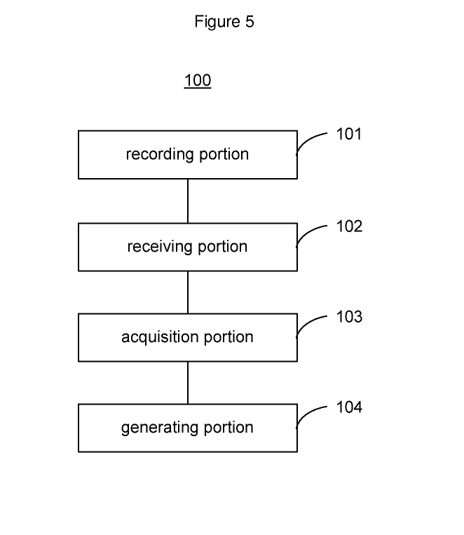

Referring to FIG. 5, the third embodiment of the disclosure provides an apparatus 100 for generating a personalized page, which includes a recording portion 101, a receiving portion 102, an acquisition portion 103 and a generating portion 104. It should be appreciated that each of the above portions refers to a computer program or program segment for implementing one or more specific functions. In addition, the division of the above portions doesn't always mean that practical program codes must be separated.

the recording portion 101 is configured to configured to record various characteristic behaviours of a user when the user visits a website, and for each of the characteristic behaviours, record information of a subject matter corresponding to the characteristic behaviour;

the receiving portion 102 is configured to receive a page request from a client and in response to the page request, detect a current behaviour of the user;

the acquisition portion 103 is configured to acquire recorded information of all subject matters corresponding to the current behaviour when the current behaviour belongs to one of the various characteristic behaviours; and the generating portion 104 is configured to generate a personalized page according to the information of all subject matters corresponding to the current behaviour, and to return the personalized page to the client.

Regarding the specific operation process of the respective portion above, the method for generating a personalized page according to the first embodiment can be further referred to, which will not be repeated herein.

In conclusion, the apparatus 100 for generating a personalized page provided by the embodiment records information of subject matters corresponding to various characteristic behaviours when a user visits a website, and when the user visits the website again, generates a personalized page according to the need reflected by a current behaviour of the user, thus it can improve the click rate of content on a web page.

### Fourth Embodiment

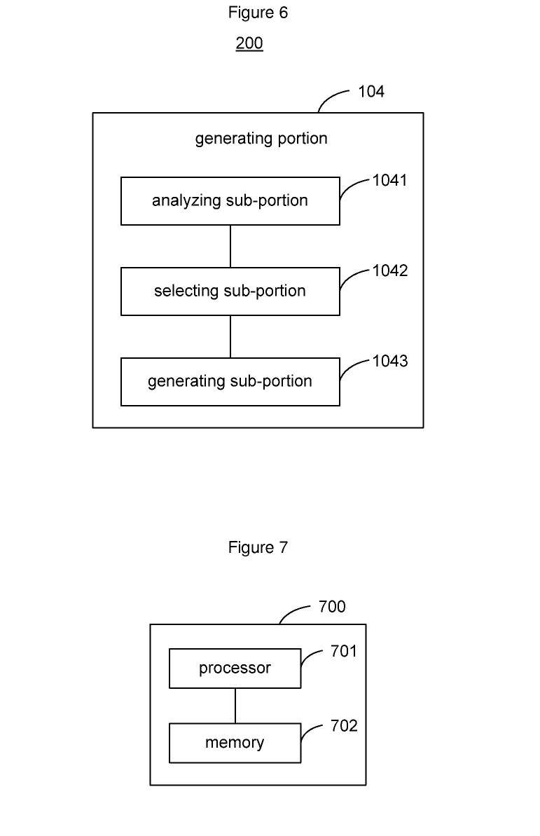

Referring to FIG. 6, the fourth embodiment of the disclosure provides an apparatus 200 for generating a personalized page, compared to the apparatus 100 for generating a personalized page according to the third embodiment, the generating portion 104 includes:

an analyzing sub-portion 1041 configured to analyze a matching feature of a desired subject matter according to the current behaviour;

a selecting sub-portion 1042 configured to select, from acquired information of all subject matters, information of a subject matter corresponding to the matching feature of the desired subject matter; and

a generating sub-portion 1043 configured to generate a personalized page according to the selected information of the subject matter corresponding to the matching feature of the desired subject matter and returning the personalized page to the client.

Regarding the specific operation process of the respective portion above, the method for generating a personalized page according to the second embodiment can be further referred to, which will not be repeated herein.

In conclusion, the apparatus 200 for generating a personalized page provided by the embodiment can select more accurately information of a subject matter more in line with a user's interest and need so as to generate a personalized page from information of all subject matters corresponding to a current behaviour, thus it can further improve click rate of content on a web page.

FIG. 7 is a block diagram illustrating a server for generating a personalized page according to some embodiments. The server may include the apparatus illustrated in each of FIGS. 5-6 and adopt the method illustrated in each of FIGS. 1-4. In an example, the server 700 can include a processor 701 and a memory 702.

In an example, the processor 701 includes hardware for executing instructions, for example, one or more computer programs. The processor 701 may retrieve instructions from the memory 702 and execute them. The processor 701 may be implemented as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform one or more of the method steps as described in the specification.

In an example, the memory 702 may store instructions for the processor 701 to execute or data for the processor 702 to operate on. In an example, the memory 702 may include random access memory (RAM), which may be dynamic RAM (DRAM) or static RAM (SRAM) as desired. Additionally, the memory 702 may include storage for storing data and instructions, such as read-only memory (ROM), such as mask-programmed ROM, programmable ROM (PROM), erasable PROM (EPROM), electrically erasable PROM (EEPROM), electrically alterable ROM (EAROM), or flash memory. In an example, the storage may be internal or external to server 700. In an example, the storage stores instructions for performing one or more of the method steps as described in the specification. As an example and not by way limitation, the server 700 may load instructions from the storage or other sources (for example, remote sources) to the RAM, and then the processor 701 may retrieve the instructions from the RAM to execute them. In an example, the memory 702 may include one or more memories.

Although this disclosure describes and illustrates a particular computer equipment having a particular number of particular components in a particular arrangement, any suitable computer equipment having any suitable number of any suitable components can be contemplated.

Herein, one or more non-transitory computer readable storage media may be contemplated for implementing any suitable storage. In an example, a non-transitory computer readable storage medium may implement at least some portions of the memory 502 or 602. The non-transitory computer readable storage medium may be implemented as a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a

SECURE DIGITAL card, a SECURE DIGITAL drive, or any other suitable computer-readable storage medium. The non-transitory computer readable storage medium may carry instructions, which when executed, causes at least one of the data traffic prompting methods provided in the disclosure to be performed.

While the foregoing disclosure discusses illustrative aspects and/or embodiments, it should be noted that various changes and modifications could be made herein without departing from the scope of the described aspects and/or embodiments as defined by the appended claims.

1. A method for generating a personalized page, comprising:
recording various characteristic behaviours of a user when the user visits a website, and, for each of the characteristic behaviours, recording information of a subject matter corresponding to the characteristic behaviour;
receiving a page request from a client and, in response to the page request, detecting a current behaviour of the user ;
if the current behaviour belongs to one of the various characteristic behaviours, acquiring recorded information of all subject matters corresponding to the current behaviour; and
generating a personalized page according to the information of all subject matters corresponding to the current behaviour, and returning the personalized page to the client.

2. The method for generating a personalized page according to claim 1, wherein the various characteristic behaviours are prioritized.

3. The method for generating a personalized page according to claim 2, wherein the step of acquiring recorded information of all subject matters corresponding to the current behaviour further comprises:
if there is no subject matter corresponding to the current behaviour, acquiring, among all characteristic behaviours with a lower priority than a characteristic behaviour to which the current behaviour belongs, information of all the subject matters corresponding to one characteristic behaviour having a corresponding subject matter and with a highest priority.

4. The method for generating a personalized page according to claim 3, wherein the step of generating a personalized page according to the information of all subject matters corresponding to the current behaviour further comprises:
analyzing a matching feature of a desired subject matter according to the current behaviour;
selecting, from acquired information of all subject matters, information of a subject matter corresponding to the matching feature of the desired subject matter; and
generating a personalized page according to the selected information of the subject matter corresponding to the matching feature of the desired subject matter.

5. The method for generating a personalized page according to claim 4, wherein the desired subject matter has a plurality of matching features, and the plurality of matching features of the desired subject matter are prioritized.

6. The method for generating a personalized page according to claim 5, wherein the step of selecting from acquired information of all subject matters information of a subject matter corresponding to the matching feature of the desired subject matter comprises:
selecting, among the plurality of matching features of the desired subject matter, information of a subject matter corresponding to a matching feature having a corresponding subject matter and with a highest priority.

7. An apparatus for generating a personalized page, comprising:
a recording portion, configured to record various characteristic behaviours of a user when the user visits a website, and, for each of the characteristic behaviours, record information of a subject matter corresponding to the characteristic behaviour;
a receiving portion, configured to receive a page request from a client and, in response to the page request, detect a current behaviour of the user;
an acquisition portion, configured to acquire recorded information of all subject matters corresponding to the current behaviour when the current behaviour belongs to one of the various characteristic behaviours; and
a generating portion, configured to generate a personalized page according to the information of all subject matters corresponding to the current behaviour, and to return the personalized page to the client.

8. The apparatus for generating a personalized page according to claim 7, wherein the various characteristic behaviours are prioritized.

9. The apparatus for generating a personalized page according to claim 8, wherein the acquisition portion is further configured to, when there is no subject matter corresponding to the current behaviour, acquire, among all characteristic behaviours with a lower priority than a characteristic behaviour to which the current behaviour belongs, information of all the subject matters corresponding to one characteristic behaviour having a corresponding subject matter and with a highest priority.

10. The apparatus for generating a personalized page according to claim 9, wherein the generating portion comprises:
an analyzing sub-portion, configured to analyze a matching feature of a desired subject matter according to the current behaviour;
a selecting sub-portion, configured to select, from acquired information of all subject matters, information of a subject matter corresponding to the matching feature of the desired subject matter ; and
a generating sub-portion, configured to generate a personalized page according to the selected information of the subject matter corresponding to the matching feature of the desired subject matter and returning the personalized page to the client.

11. The apparatus for generating a personalized page according to claim 10, wherein the desired subject matter has a plurality of matching features, and the plurality of matching features of the desired subject matter are prioritized.

12. The apparatus for generating a personalized page according to claim 11, wherein the selecting sub-portion is configured to select, among the plurality of matching features of the desired subject matter, information of a subject matter corresponding to a matching feature having a corresponding subject matter and with a highest priority.

13. (canceled)

14. A non-transitory computer-readable storage medium including instructions that, when executed, cause a processor to perform:
recording various characteristic behaviors of a user when the user visits a website, and, for each of the characteristic behaviors, recording information of a subject matter corresponding to the characteristic behavior;
receiving a page request from a client and, in response to the page request, detecting a current behavior of the user;
if the current behavior belongs to one of the various characteristic behaviors, acquiring recorded information of all subject matters corresponding to the current behavior; and
generating a personalized page according to the information of all subject matters corredponding to the current behavior, and returning the personalized page to the client.

15. The non-transitory computer-readable storage medium according to claim 14, wherein the various characteristic behaviours are prioritized.

16. The non-transitory computer-readable storage medium according to claim 15, wherein the step of acquiring recorded information of all subject matters corresponding to the current behaviour further comprises:
if there is no subject matter corresponding to the current behaviour, acquiring, among all characteristic behaviours with a lower priority than a characteristic behaviour to which the current behaviour belongs, information of all the subject matters corresponding to one characteristic behaviour having a corresponding subject matter and with a highest priority.

17. The non-transitory computer-readable storage medium according to claim 16, wherein the step of generating a personalized page according to the information of all subject matters corresponding to the current behaviour further comprises:
analyzing a matching feature of a desired subject matter according to the current behaviour;
selecting, from acquired information of all subject matters, information of a subject matter corresponding to the matching feature of the desired subject matter; and
generating a personalized page according to the selected information of the subject matter corresponding to the matching feature of the desired subject matter.

18. The non-transitory computer-readable storage medium according to claim 17, wherein the desired subject matter has a plurality of matching features, and the plurality of matching features of the desired subject matter are prioritized.

19. The non-transitory computer-readable storage medium according to claim 18, wherein the step of selecting from acquired information of all subject matters information of a subject matter corresponding to the matching feature of the desired subject matter comprises:
selecting, among the plurality of matching features of the desired subject matter, information of a subject matter corresponding to a matching feature having a corresponding subject matter and with a highest priority.
